(19) United States
(12) Patent Application Publication
(10) Pub. No.: US 2016/0245491 A1
(43) Pub. Date: Aug. 25, 2016

(54) TRANSPARENT LIGHT EMITTING APPARATUS

(71) Applicant: Kumho Electric, Inc., Seoul (KR)

(72) Inventor: Byung Hyun KIM, Gyeonggi-do (KR)

(73) Assignee: Kumho Electric, Inc.

(21) Appl. No.: 14/695,149

(22) Filed: Apr. 24, 2015

(30) Foreign Application Priority Data
Feb. 25, 2015 (KR) 10-2015-0026675

(51) Int. Cl. F21V 23/00; F21V 23/02

(52) U.S. Cl. CPC F21V 23/001; F21V 23/02; F21Y 2101/02; F21Y 2105/001

(57) ABSTRACT

Disclosed is a transparent light emitting apparatus including a first transparent substrate, a wiring sheet including a base layer disposed on the first transparent substrate and a plurality of wiring electrodes formed on the base layer, and a plurality of light emitting diode (LED) packages electrically connected to the wiring electrodes.

### CROSS-REFERENCE TO RELATED APPLICATION

This application claims priority to and the benefit of Korean Patent Application No. 2015-0026675, filed on Feb. 25, 2015, the disclosure of which is incorporated herein by reference in its entirety.

### BACKGROUND

1. Field of the Invention

The present invention relates to a transparent light emitting apparatus using light emitting diodes (LED).

2. Discussion of Related Art

Recently, transparent light emitting apparatuses have been generally used in lightings, indoor and outdoor advertising boards, billboards, and signs. In a transparent light emitting apparatuses, transparent wiring is formed on a glass substrate and a light emitting diode (LED) is connected to the transparent wiring.

Light emitting apparatuses using LEDs are driven using low power and have a long life, and thus used in various fields such as large outdoor electronic boards and indoor small electronic displays.

However, in the case of indium tin oxide (ITO) used as transparent wiring, since an LED cannot be directly soldered thereto, a manufacturing process becomes complicated and thermal resistance is high.

Also, ITO is expensive and easily damaged by flexure or other physical stresses. Also, to obtain high conductivity, high deposition temperature and/or high annealing temperature are necessary.

### SUMMARY OF THE INVENTION

The present invention is directed to a transparent light emitting apparatus which is manufactured through a simple process and is able to reduce manufacturing costs.

The present invention is also directed to a flexible transparent light emitting apparatus.

According to an aspect of the present invention, there is provided a transparent light emitting apparatus including a first transparent substrate, a wiring sheet including a base layer disposed on the first transparent substrate and a plurality of wiring electrodes formed on the base layer, and a plurality of light emitting diode (LED) packages electrically connected to the wiring electrodes.

Each of the wiring electrodes may be made of a conducting wire having a width of from about 2 μm to about 20 μm.

Each of the wiring electrodes may include metal mesh.

The base layer may have a thickness of from about 50 μm to about 300 μm.

The transparent light emitting apparatus may include conductive layers configured to electrically connect the LED packages with the wiring electrodes.

A pitch of the metal mesh may be 400 μm or less, and a width of the metal mesh may be 7 μm or more.

The transparent light emitting apparatus may include a second transparent substrate disposed separately from the first transparent substrate and a filler disposed between the first transparent substrate and the second transparent substrate to cover the LED packages.

The wiring sheet may include an interface portion protruding outward from the first transparent substrate and electrically connected to an external power supply, and the interface portion may include electrode patterns electrically connected to the wiring electrodes.

The wiring sheet may be manufactured through a roll-to-roll process.

The transparent light emitting apparatus may include a quadrangular frame disposed in an edge area of the first transparent substrate and a transparent filler configured to fill the frame to cover the plurality of LED packages.

The transparent light emitting apparatus may include a second transparent substrate disposed separately from the first transparent substrate by the frame.

According to another aspect of the present invention, there is provided a transparent light emitting apparatus including a wiring sheet including a flexible base layer and a plurality of wiring electrodes formed on the base layer and a plurality of LED packages electrically connected to the wiring electrodes.

Each of the wiring electrodes may be made of a conducting wire having a width of from about 2 μm to about 20 μm.

Each of the wiring electrodes may include metal mesh.

The wiring sheet may include an interface portion protruding from an end of the base layer and electrically connected to an external power supply, and the interface portion may include electrode patterns electrically connected to the wiring electrodes.

The transparent light emitting apparatus may include a quadrangular frame disposed in an edge area of the base layer and a transparent filler configured to fill the frame to cover the plurality of LED packages.

The transparent light emitting apparatus may include a protective film disposed separately from the base layer.

A pitch of the metal mesh may be 400 μm or less, and a width of the metal mesh may be 7 μm or more.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1A is a view of a transparent light emitting apparatus according to an embodiment of the present invention;

FIG. 1B is illustrates a modification of the coupling relation shown in FIG. 1A;

FIG. 2 is a top view of a first transparent substrate according to an embodiment of the present invention;

FIG. 3A is an enlarged view illustrating a portion A of FIG. 2;

FIG. 3B illustrates examples of a shape of metal mesh shown in FIG. 3A;

FIG. 4 is an enlarged view illustrating a portion B of FIG. 3;

FIG. 5 is a side view of the transparent light emitting apparatus according to an embodiment of the present invention;

FIG. 6 is a schematic cross-sectional view of a transparent light emitting apparatus according to another embodiment of the present invention;

FIG. 7 is a view illustrating a configuration in which an interface portion of the transparent light emitting apparatus is electrically connected to a control unit according to another embodiment of the present invention;

FIG. 8 is an enlarged view of the interface portion of the transparent light emitting apparatus according to another embodiment of the present invention; and

FIG. 9 is a view illustrating a configuration in which the transparent light emitting apparatus is attached to a substrate according to another embodiment of the present invention.

FIG. 10 is a schematic cross-sectional view of a transparent light emitting apparatus according to another embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

The present invention may have various modifications and several embodiments, and exemplary embodiments thereof are shown in the drawings and will be described in detail.

However, the present invention will not be limited to the exemplary embodiments but should be understood as including all modifications, equivalents, and substitutes included in the spirit and the technical scope of the present.

In the present specification, terms of “comprise” or “have” are used to designate features, numbers, steps, operations, elements, components or combinations thereof disclosed in the specification as being present but not preclude possibility of the existence or the addition of one or more other features, numbers, steps, operations, elements, components, or combinations thereof.

Also, it will be understood that the attached drawings are to be enlarged or reduced for convenience of description.

The embodiments of the present invention will be described with reference to the drawings. Throughout the specification, like reference numerals designate like elements and a repetitive description thereof will be omitted.

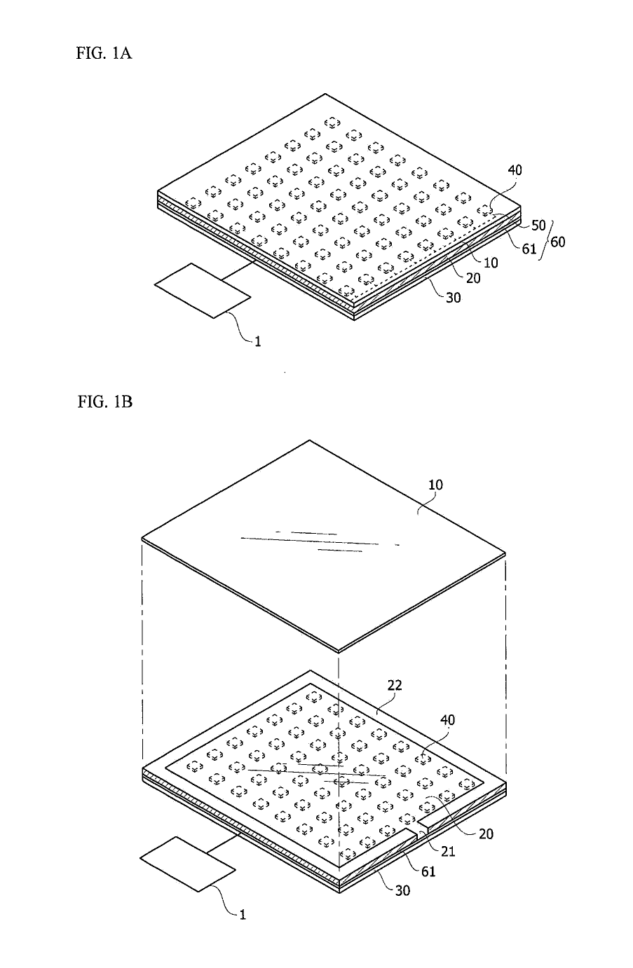

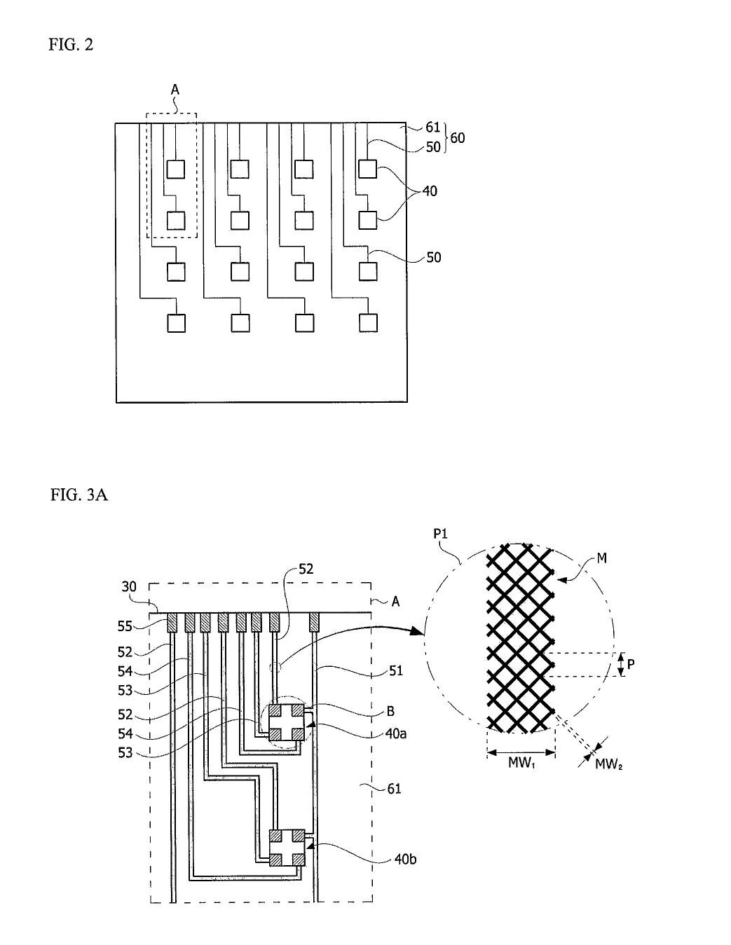

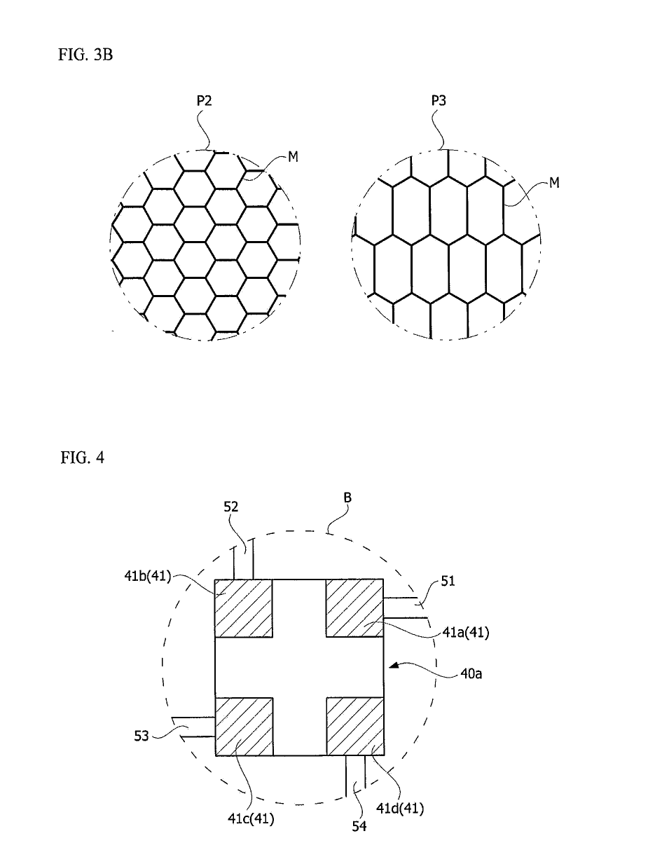

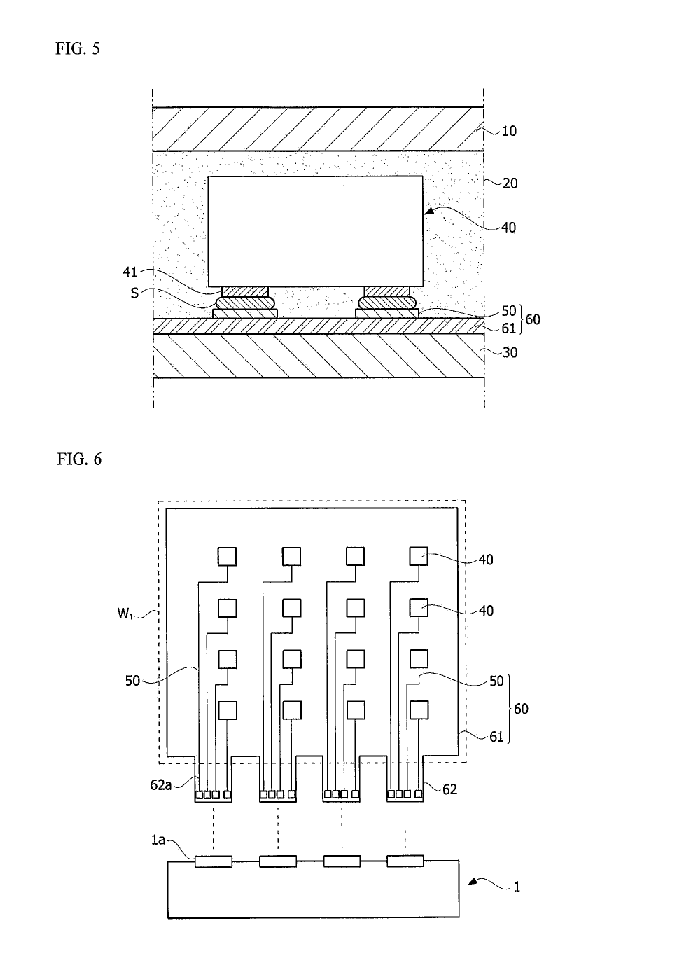

FIG. 1A is a view of a transparent light emitting apparatus according to an embodiment of the present invention. FIG. 1B is illustrates a modification of the coupling relation shown in FIG. 1A. FIG. 2 is a top view of a first transparent substrate 30 according to an embodiment of the present invention. FIG. 3A is an enlarged view illustrating a portion A of FIG. 2, and FIG. 3B illustrates examples of a shape of metal mesh shown in FIG. 3A. FIG. 4 is an enlarged view illustrating a portion B of FIG. 3. FIG. 5 is a side view of the transparent light emitting apparatus according to an embodiment of the present invention.

Referring to FIG. 1A and FIG. 2, the transparent light emitting apparatus includes the first transparent substrate 30, a wiring sheet 60 disposed on the first transparent substrate 30, and a plurality of light emitting diode (LED) packages 40 disposed on the wiring sheet 60.

To the first transparent substrate 30 and a second transparent substrate 10, all substrates having transparent materials may be applied. As an example, the first transparent substrate 30 and the second transparent substrate 10 may be glass substrates. The first transparent substrate 30 and the second transparent substrate 10 may be manufactured in various sizes according to general standards of glass in building.

A transparent filler 20 is disposed between the first transparent substrate 30 and the second substrate 10, thereby fixing and protecting the plurality of LED packages 40. As the transparent filler 20, various types of polymer resin may be selected.

The wiring sheet 60 includes a base layer 61 and a plurality of wiring electrodes 50 formed on the base layer 61. The base layer 61 may be a polymer film formed of one of polyethylene terephthalate (PET), polycarbonate (PC), and polymethyl methacrylate (PMMA).

The plurality of wiring electrodes 50 may be one of conducting wires and metal mesh. Here, the wiring electrodes 50 may be transparent electrodes which are not visible to the naked eye at a predetermined distance. When being formed at a width of about 2 to about 20 μm, the conducting wires are not easily visible to the naked eye. To increase transparency, a line width of the conducting wires may be formed to be about 2 to about 10 μm.

Also, since being patterned with a width of about several μm or less, the metal mesh are substantially transparent. The wiring electrode 50 may be formed by forming a copper (Cu) layer on the base layer 61 and patterning the Cu layer. That is, it is possible to form conducting wires by pattering as lines of a single line type or to pattern as a mesh shape. Hereinafter, it will be described that the wiring electrode 50 is metal mesh.

A thickness of the base layer 61 may be from about 50 μm to about 300 μm. When the thickness is less than 50 μm, it is difficult to maintain full strength while joining the LED packages 40. When the thickness is more than 300 μm, since transparency decreases, it is difficult to perform a function of the transparent light emitting apparatus. The plurality of wiring electrode 50 may be formed depending on the number of the LED packages 40 and an electrode type.

The plurality of LED packages 40 are arranged in a matrix form on the wiring sheet 60. There is no limitation on the number of the LED packages, and an appropriate number of the LED packages may be arranged to provide text or images. The LED packages 40 individually receive power from a control unit 1 to be driven.

Referring to FIG. 1B, a quadrangular frame 22 may be disposed in an edge area of the base layer 61 of the wiring sheet 60 and the transparent filler 20 may be disposed inside the frame 22. The frame 22 may be a double-sided tap having a certain thickness. The second transparent substrate 10 may be disposed separately from the first transparent substrate 30 due to the thickness of the frame 22.

However, it is not limited thereto. The frame 22 may be manufactured by forming one or more selected from SiO₂, SiₓO_{y}, Si₃N₄, SiN, SiOₓN_{y}, AI₂O₃, TiO₂, and AlN on an edge area of one of the base layer 61 and the second transparent substrate 10.

An injection hole is formed on one side of the frame 22, and the transparent filler 20 may be injected. That is, edges of the first transparent substrate 30 and the second transparent substrate 10 are sealed with the frame 22 and then the transparent filler 20 may be injected through the injection hole.

The transparent filler 20 may include a protrusion 21 inserted into the injection hole. That is, the protrusion 21 may protrude outward from a filling area defined by the frame 22.

One injection hole is shown in FIG. 1B but may be formed in respective edges. Accordingly, the protrusion may be formed in respective edges. According to a structure described above, a flow of the transparent filler 20 is improved, thereby reducing an unfilled area.

Referring to FIGS. 3A to 4, each of the LED packages 40 includes a plurality of electrodes 41. In detail, the LED package 40 may include three drive electrodes 41b, 41c, and 41d, and one common electrode 41a. A pitch between the LED packages 40 may be from about 5 mm to about 50 mm.

The drive electrodes 41b, 41c, and 41d may be anodes, and the common electrode 41a may be a cathode. The LED package 40 may be a package formed by modularizing a blue LED chip, a green LED chip, and a red LED chip.

In detail, a wiring electrode 51 (hereinafter referred to as a common wiring electrode) connected to the common electrode 41a of the LED package 40 and wiring electrodes 52, 53, and 54 (hereinafter referred to as drive wiring electrodes) connected to the drive electrodes 41b, 41c, and 41d of the LED package 40 are formed on the base layer 61 of the wiring sheet 60.

Electrode pads 55 are formed on ends of the wiring electrodes 50, respectively. The electrode pad 55 may be electrically connected to a printed circuit board (PCB) and may apply power to the LED package 40.

For example, when power is applied to a first drive wiring electrode 52 while power is being applied to the common wiring electrode 51, the LED package 40 may emit blue light. Also, when power is applied to all first to third drive wiring electrodes 52, 53, and 54, the LED package 40 may emit white light. Accordingly, various colors of light may be emitted by selectively applying power to the first to third drive wiring electrodes 52, 53, and 54. Also, a color temperature may be adjusted by controlling currents.

The common wiring electrode 51 is connected to the common electrodes 41a of a plurality of LED packages 40a and 40b in common. Also, the drive wiring electrodes 52, 53, and 54 are connected to the drive electrodes 41b, 41c, and 41d of the LED package 40, respectively.

The common wiring electrode 51, the drive wiring electrodes 52, 53, and 54, and the electrode pad 55 may be manufactured as metal mesh M. In detail, a mesh layer is formed on the base layer 61 and then patterned, thereby forming a wiring electrode.

General indium tin oxide (ITO) wiring electrodes are formed with a large area to reduce resistance. However, when manufactured using a conducting wire or metal mesh, a thin wiring electrode may be manufactured due to relatively lower resistance. Accordingly, it is of great advantage to manufacture light emitting apparatuses with high resolution.

Also, since the wiring electrode is manufactured on the base layer 61 and then stuck to a glass substrate, a manufacturing process becomes simplified. Since a large conducting pattern or mesh pattern may be formed through a roll-to-roll process and a patterning process and may be attached to a glass substrate, it is easy to manufacture a large transparent light emitting apparatus.

The metal mesh M has a quadrangular shape in P1 of FIG. 3A but is not limited thereto. As shown in P2 of FIG. 3B, the metal mesh M may include consecutively arranged regular hexagons. Alternatively, as shown in P3 of FIG. 3B, the metal mesh M may include consecutively arranged hexagons. Although not shown in the drawings, polygons may be consecutively arraigned.

According to a structure described above, since contact points of the metal mesh M increase, resistance and a risk of disconnection may be reduced.

Table 1 below shows a result of measuring resistance values when metal mesh which has a channel with a width MW1 of about 790 μm and a length 250 mm varies in thickness, pitch P, and line width MW2 of the metal mesh.

TABLE 1

| Thicknesses (□) | Pitches (μm) | Widths (μm) | Resistance value (Ω) |
|---|---|---|---|
| 3000 | 300 | 3 | 2177 |
| | | 5 | 1303 |
| | | 7 | 929 |
| | 400 | 3 | 3511 |
| | | 5 | 2102 |
| | | 7 | 1499 |
| 4000 | 300 | 3 | 1634 |
| | | 5 | 977 |
| | | 7 | 696 |
| | 400 | 3 | 2632 |
| | | 5 | 1575 |
| | | 7 | 954 |
| 5000 | 300 | 3 | 1633 |
| | | 5 | 781 |
| | | 7 | 557 |
| | 400 | 3 | 2105 |
| | | 5 | 1261 |
| | | 7 | 899 |

To allow optical power of the plurality of LED packages 40 to be uniform, it is necessary that resistance of a wiring electrode is 1 kΩ or less. Referring to Table 1, it can be known that although a thickness varies, a resistance value is 1 kΩ or less when a pitch is 400 μm or less and a width is 7 μm or more.

Accordingly, since resistance is not more than 1 kΩ when it is satisfied that the pitch of the metal mesh M is 400 μm or less and the width is 7 μm or more, although the thickness of the metal mesh varies, it is possible to uniformly control the optical power of the plurality of LED packages 40. Here, for transparency, the line width of the metal mesh may be 20 μm or less.

Also, when the pitch of the metal mesh M is from about 300 μm to about 400 μm and the width is from about 10 μm to about 20 μm, although a length of the wiring electrode becomes longer, it is possible to uniformly control the optical power of the plurality of LED packages 40.

Referring to FIG. 5, the electrode 41 of the LED package 40 may be electrically connected to the wiring electrode 50 through a silver paste S that is a conductive layer. Since the transparent filler 20 is disposed between the first transparent substrate 30 and the second substrate 10, it is possible to firmly fix the LED package 40.

According to one embodiment of the present invention, since the wiring electrode 50 is formed on the base layer 61, there is provided a higher level of adhesion than that of directly forming a wiring electrode on a glass substrate. Also, the thickness of the base layer 61 is from about 50 μm to about 300 μm, it is possible to maintain full transparency.

Since a general ITO has high thermal resistance, a silver paste is applied onto the ITO and the silver paste and an electrode of an LED package are electrically connected through soldering.

However, according to one embodiment of the present invention, the wiring electrode 50 has low thermal resistance because it is metal, it is possible to provide an electrical connection with the electrode 41 of the LED package 40 only using a silver paste. Accordingly, additional soldering may be omitted.

Since a curing temperature of the silver paste is relatively low, the base layer 61 is not melted. Accordingly, a conductive layer which connects an LED package with a wiring electrode contains silver. According to one embodiment of the present invention, since a soldering process which is performed at a high temperature may be omitted using a metal as a wiring electrode, it is possible to manufacture a large wiring sheet using a base layer. If necessary, an additional buffer layer may be further formed on the wiring electrode 50.

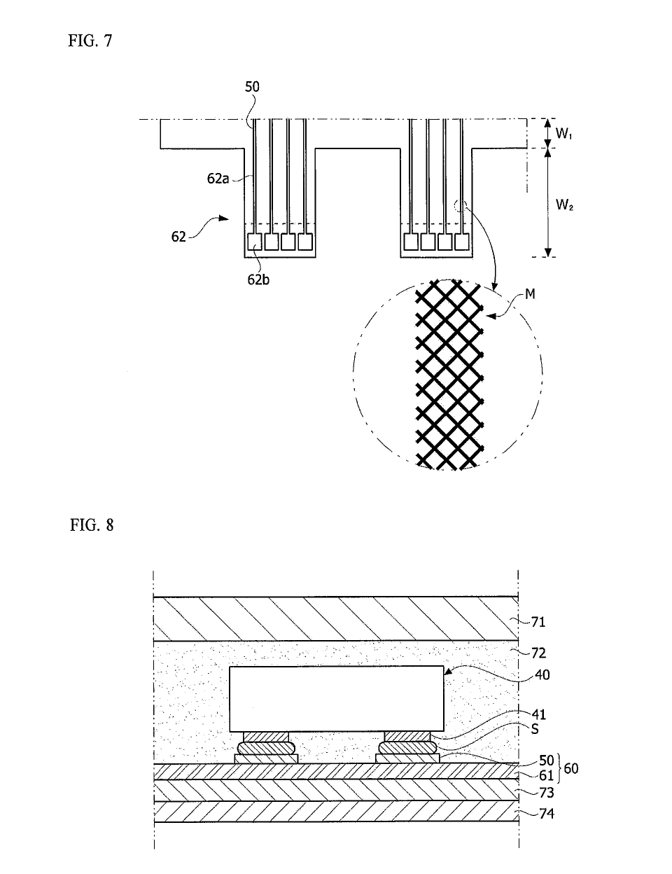

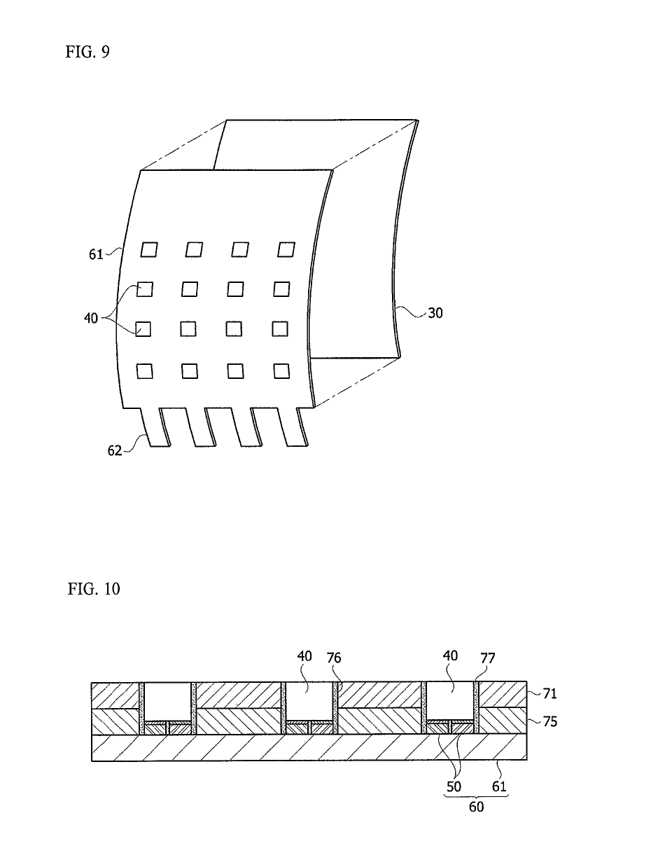

FIG. 6 is a schematic cross-sectional view of a transparent light emitting apparatus according to another embodiment of the present invention. FIG. 7 is a view illustrating a configuration in which an interface portion 62 of the transparent light emitting apparatus is electrically connected to a control unit 1 according to another embodiment of the present invention. FIG. 8 is an enlarged view of the interface portion 62 of the transparent light emitting apparatus according to another embodiment of the present invention. FIG. 9 is a view illustrating a configuration in which the transparent light emitting apparatus is attached to a substrate 30 according to another embodiment of the present invention.

Referring to FIG. 6, the transparent light emitting apparatus according to another embodiment of the present invention includes a wiring sheet 60 which includes a plurality of wiring electrodes 50 formed on a flexible base layer 61, a plurality of LED packages 40 electrically connected to the wiring electrodes 50 through a silver paste S, a protective film 71 disposed separately from the wiring sheet 60, and a filler 72 disposed between the protective film 71 and the wiring sheet 60.

According to the configuration described above, the base layer 61 and the protective film 71 perform as a substrate instead of a transparent substrate, thereby manufacturing a flexible transparent light emitting apparatus.

A thickness of the base layer 61 may be from about 50 μm to about 300 μm. When the thickness is less than 50 μm, it is impossible to maintain full strength and it is difficult to fully support the joining of the LED package 40. When the thickness is more than 300 μm, since transparency decreases, it is difficult to perform a function of the transparent light emitting apparatus.

Since the base layer 61 has relatively lower strength than a glass substrate, it is possible to maintain necessary strength by providing a full thickness of the filler 72. As an example, when the filler 72 has a thickness of from about 1.0 to about 2.0 times of a thickness of the LED package 40, the necessary strength may be provided.

As described with reference to FIG. 1B, a frame may be formed on the base layer 61 and the filler 72 may be injected into a filling area defined by the frame. That is, the configuration of the frame and the filler described above may be applied without change except that a flexible substrate is used. The protective film 71 may be disposed separately from the base layer 61 as far as a thickness of the frame. The protective film 71 may be one of all substantially transparent films.

Since detailed configurations of the wiring sheet 60 and the LED package 40 are identical to the described above, a repetitive description thereof will be omitted and particular features will be described in detail.

Referring to FIGS. 7 and 8, the wiring sheet 60 includes a plurality of interface portions 62 which protrude from an end of the base layer 61 and are electrically connected to an external power supply.

The interface portion 62 includes an electrode pattern 62a electrically connected to the wiring electrode 50 and a pad 62b. The electrode pattern 62a and the pad 62b may be metal mesh M identical to the wiring electrode 50.

The transparent light emitting apparatus may be divided into an active area W1 which outputs images to be displayed and an inactive area W2. The interface portions 62 are disposed in the inactive area W2.

The interface portions 62 may be manufactured by forming the wiring electrode 50, the electrode pattern 62a, and the pad 62b by patterning a mesh layer formed on the base layer 61 and cutting an area in which the electrode pattern 62a is not formed.

The interface portion 62 may be directly connected to a connector 1a of the control unit 1 and may apply power to the wiring electrode 50. Accordingly, it is possible to omit an additional PCB.

Referring to FIG. 6, an adhesive layer 73 and a cover layer 74 may be formed on the other surface of the base layer 61. Accordingly, the cover layer 74 may be detached and the transparent light emitting apparatus may be attached to a desirable substrate 30 as shown in FIG. 9.

As described above, because the transparent light emitting apparatus is flexible, it may be attached anywhere on a curved substrate to display images.

For example, in an embodiment of the present invention, a configuration of interface portions may be added. In this case, the interface portions may protrude outward from a first transparent substrate and may be electrically connected to a control unit.

According to one embodiment of the present invention, a conducting wire or metal mesh is used instead of indium tin oxide (ITO), thereby reducing manufacturing costs and manufacturing a large light emitting apparatus.

Also, since a base layer is used as a substrate instead of a glass substrate, it is possible to manufacture a flexible transparent light emitting apparatus.

FIG. 10 is a schematic cross-sectional view of a transparent light emitting apparatus according to another embodiment of the present invention.

Referring to FIG. 10, the transparent light emitting apparatus according to another embodiment of the present invention includes a wiring sheet 60 which includes a plurality of wiring electrodes 50 formed on a flexible base layer 61, a plurality of LED packages 40 electrically connected to the wiring electrodes 50, a protective film 71 disposed separately from the wiring sheet 60, and an optical adhesive 75 disposed between the protective film 71 and the wiring sheet 60.

The protective film 71 and the optical adhesive 75 have a plurality of holes in which the plurality of LED packages 40 are inserted. Thus, the plurality of LED packages 40 may be exposed towards the exterior of the protective film 71. The optical adhesive 75 may be a pressure sensitive adhesive (PSA) or an optical clearance adhesive (OCA).

A non-conductive material 77 is injected in a space between the plurality of holes and the plurality of LED packages 40 to protect the plurality of LED packages 40 and the plurality of wiring electrodes 50. As the non-conductive material, various types of polymer resin may be selected.

According to the configuration described above, it is possible to omit a process in which a filler is injected between the protective film 71 and the wiring sheet 60 so that the manufacturing process of the transparent light emitting apparatus becomes simplified.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A transparent light emitting apparatus comprising:
a first transparent substrate;
a wiring sheet comprising a base layer disposed on the first transparent substrate and a plurality of wiring electrodes formed on the base layer; and
a plurality of light emitting diode (LED) packages electrically connected to the wiring electrodes.

2. The transparent light emitting apparatus of claim 1, wherein each of the wiring electrodes is made of a conducting wire having a width of from about 2 μm to about 20 μm.

3. The transparent light emitting apparatus of claim 1, wherein each of the wiring electrodes comprises metal mesh.

4. The transparent light emitting apparatus of claim 1, wherein the base layer has a thickness of from about 50 μm to about 300 μm.

5. The transparent light emitting apparatus of claim 1, comprising conductive layers configured to electrically connect the LED packages with the wiring electrodes.

6. The transparent light emitting apparatus of claim 3, wherein a pitch of the metal mesh is 400 μm or less and a width of the metal mesh is 7 μm or more.

7. The transparent light emitting apparatus of claim 1, comprising a second transparent substrate disposed separately from the first transparent substrate.

8. The transparent light emitting apparatus of claim 7, comprising a filler disposed between the first transparent substrate and the second transparent substrate to cover the LED packages.

9. The transparent light emitting apparatus of claim 1, wherein the wiring sheet comprises an interface portion protruding outward from the first transparent substrate and electrically connected to an external power supply, and
wherein the interface portion comprises electrode patterns electrically connected to the wiring electrodes.

10. The transparent light emitting apparatus of claim 1, wherein the wiring sheet is manufactured through a roll-to-roll process.

11. The transparent light emitting apparatus of claim 1, comprising:
a quadrangular frame disposed in an edge area of the first transparent substrate; and
a transparent filler configured to fill the frame to cover the plurality of LED packages.

12. The transparent light emitting apparatus of claim 11, comprising a second transparent substrate disposed separately from the first transparent substrate by the frame.

13. A transparent light emitting apparatus comprising:
a wiring sheet comprising a flexible base layer and a plurality of wiring electrodes formed on the base layer; and
a plurality of LED packages electrically connected to the wiring electrodes.

14. The transparent light emitting apparatus of claim 13, wherein each of the wiring electrodes is made of a conducting wire having a width of from about 2 μm to about 20 μm.

15. The transparent light emitting apparatus of claim 13, wherein each of the wiring electrodes comprises metal mesh.

16. The transparent light emitting apparatus of claim 13, wherein the wiring sheet comprises an interface portion protruding from an end of the base layer and electrically connected to an external power supply, and
wherein the interface portion comprises electrode patterns electrically connected to the wiring electrodes.

17. The transparent light emitting apparatus of claim 13, comprising:
a quadrangular frame disposed in an edge area of the base layer; and
a transparent filler configured to fill the frame to cover the plurality of LED packages.

18. The transparent light emitting apparatus of claim 13, comprising a protective film disposed separately from the base layer.

19. The transparent light emitting apparatus of claim 15, wherein a pitch of the metal mesh is 400 μm or less and a width of the metal mesh is 7 μm or more.
